(19) United States
(12) Patent Application Publication
(10) Pub. No.: US 2011/0065062 A1
(43) Pub. Date: Mar. 17, 2011

(54) Apparatus and Method for Hands-Free Fluid Evacuation

(75) Inventor: Ann Arrington, Pleasant View, UT (US)

(73) Assignee: BLUE BOA LLC, Pleasant View, UT (US)

(21) Appl. No.: 12/559,431

(22) Filed: Sep. 14, 2009

(51) Int. Cl. A61C 17/08

(52) U.S. Cl. 433/96; 433/215

(57) ABSTRACT

Disclosed is a lightweight, autoclavable, dental suction apparatus used to evacuate fluid from a patient's mouth during dental procedures. In particular, the apparatus is useful for hands-free operation in combination with high volume suction and slow speed suction and in combination with popular disposable suction devices. Further, the apparatus is comfortable for patients and provides greater patient access and comfort to clinicians.

### CROSS-REFERENCE TO RELATED APPLICATIONS

Not Applicable.

### BACKGROUND OF THE INVENTION

1. Field of the Invention

The present invention relates to dental tools and equipment and more particularly to high-volume water and saliva evacuation apparatus suitable for hands-free operation and reuse following standard sterilization methods.

2. Background and Related Art

Almost every dental procedure requires the use of water or saliva evacuation apparatus. The use of ultrasonic equipment that emits water, the introduction of water to cool drilling tools and to irrigate and rinse the mouth of treatment compounds, amalgams and removed dental material generally results in the accumulation of saliva, water and debris in the mouth that is objectionable or unhealthy to swallow. A dental clinician must manage the accumulation of such fluid continually throughout dental procedures, often requiring the aid of a dental assistant. Fluid evacuation also helps some procedures requiring a dry field to protect moisture sensitive material. The need to remove fluid from the mouth is disruptive in procedures performed by the clinician functioning without the benefit of an assistant. The clinician often experiences difficulty evacuating water and saliva while working in the mouth with water intensive instrumentation and a mirror. In such cases, the clinician must decide whether to use their free hand for suctioning, or to manipulate the mirror. If the clinician chooses the mirror, they will inevitably need to interrupt the procedure to evacuate the accumulated fluid. Without the mirror, the clinician compromises ergonomic positioning, bending and twisting at the torso and neck to see, leading to posture strains and workplace injury. The clinician cannot perform the trained skills optimally without visual clarity provided by using a mirror. Consequently, the clinician may enlist the patient to assist by holding the current standard suctioning device. Thus, clinicians frequently compromise suction efficiency so that the mirror can be used.

Typical dental equipment includes sources of both high volume suction and low volume or slow speed suction. The orifices or valves delivering and controlling the suction are generally attached to heavy hoses configured to rest in an armature or base adjacent the patient when not in use by the clinician. The orifice size of a high volume suction valve is usually different than the orifice size of the accompanying slow speed suction. Dental accessories designed for slow speed suction are typically not compatible with high volume suction and vice versa. Clinicians, however, may prefer to use an accessory sized for a slow speed suction orifice with a high volume suction valve. Alternatively, the clinician may prefer to use an accessory designed for a high volume suction orifice with a slow speed suction valve. However, in each case the clinician is prevented from such cross use due to incompatibility between the suction valve sizes. Consequently, the clinician may use temporary makeshift adaptations to enable use of favored accessories against design.

Therefore, it is an object of the invention to provide a lightweight, hands-free saliva ejection apparatus that requires no third-party or patient assistance.

It is also an object of the invention to permit the clinician to use a mirror and a water assisted instrument, allowing for excellent ergonomics and optimal clinical performance.

It is another object of the invention to provide the patient with comfortable and efficient water evacuation.

It is a further object of the invention to provide compatibility between high volume suction accessories and slow speed suction valves, and between slow speed suction accessories and high volume suction valves.

It is yet a further object of the invention to provide the above named features in an apparatus that may be thoroughly sterilized by all sterilization methods, but particularly by autoclave, allowing reuse without exposing the patient to possible cross-contamination.

These and other objects, advantages and characteristic features of the present invention will become more apparent upon consideration of the following description thereof when taken in connection with the accompanying drawings depicting the same.

### SUMMARY OF THE INVENTION

The invention is a specially constructed, light-weight suction tubing suitable for easy engagement and removal from existing high-volume suction and slow-speed suction equipment at one end, as well as industry standard disposable suction attachments at the other end. One advance made in the art of dental apparatus for saliva evacuation is that this suction tube is light-weight so as not to cause discomfort to the patient or the clinician when positioned for hands-free operation. Another advance is that the tube is easily attached to either the high-volume or slow speed suction source in the dental office.

The first part of the invention is a specifically constructed tube that is light-weight. A suction tube of the present invention weights between 0.75 and 1.5 ounces when fabricated with a single adapter end, and between 1.0 and 2.0 ounces when fabricated with dual adapter ends. The suction tubing is sufficiently light that when positioned, along with standard saliva ejectors, the weight of the tubing does not cause the combination to move out of position, nor does the weight of the tubing alone or in combination cause material discomfort to the patient.

Another purpose of the light-weight characteristic of the invention is to free the clinician from stopping the procedure to perform saliva evacuation. These advances allow the tubing to remain in position throughout the dental procedure without the need of recurring interruption to perform saliva evacuation nor intervention by a third-party assistant to perform the same. This single-person, hands-free saliva ejection allows the clinician to focus on the dental procedure with improved performance due to improved visual field using the mirror and in greater comfort and proper therapeutic form.

Another feature of the suction tubing is that it is sufficiently long that the heavy suction valve and hose may be left at rest in the base while the suction tubing is in use. In addition, the saliva ejector inserted in the suction tubing may be positioned on either side of the patient without regard to which side the source of suction is located. This placement flexibility allows the clinician to position or reposition the saliva ejector for optimal visualization and effective saliva evacuation for procedures being performed on either side of the patient's mouth.

Another advance is that the tubing is provided with a formed end capable of being easily attached to standard sources of suction. The tubing is adapted to be attached to either a low-volume or high-volume source of suction. The adaptation is comprised of a formed end capable of being attached by insertion and frictionally engaged with the suction source. Each adapter is capable of direct attachment to an HVE suction source or indirect attachment to a slow speed suction source, and may also be attached to a 0.250 (¼) inch outside diameter saliva ejector. The tube portion is also easily attachable to a saliva ejector, particularly smaller diameter saliva ejectors such as, for example, the Orsing Hygoformic™ and the Otis Formeject™ saliva ejectors. The light weight suction tubing of the present invention is preferable over both traditional HVE and standard slow speed ejection hose, valve and saliva ejector combinations. The clinician is able to reduce wrist fatigue by leaving the heavy hose and valve at rest in the base while actively applying suction with the suction tubing of the present invention. Further, the suction tubing of the present invention also reduces patient cheek drag when used in a hands-free manner.

A further advance of the tubing is that it is comprised of material selected for suitability to withstand all common types of sterilization. Thus, the tubing may be repeatedly subjected to cold, or chemical sterilization, and also to autoclaving. Therefore the dental clinician is not restricted to one form of sterilization or another to implement use of this invention. It is particularly beneficial to be able to autoclave the suction tubing to prevent cross contamination from backflow.

Because slow speed suction attachments are popular and abundant, it is a further advance of the suction tubing to adapt any slow speed suction device for use with high volume extraction. For this purpose a suction tubing with adapter portions on each end accommodates engaging slow speed suction saliva ejectors. Such second adapters can be formed to accommodate 0.250 (¼) inch suction devices or other current or future devices with differing outside diameter standards.

### BRIEF DESCRIPTION OF THE DRAWINGS

These and other features, aspects, and advantages of the present invention will become better understood with regard to the following description appended claims, and accompanying drawings where:

FIG. 1 shows a preferred embodiment of a suction tubing for a dental office constructed according to the preferred embodiment of the present invention;

FIG. 2 shows a partial cutaway view of the adapter and tube segment of the preferred embodiment of the present invention;

FIG. 3 shows another embodiment of the present invention having a double-ended suction tubing with adapters at each end.

### DETAILED DESCRIPTION OF A PREFERRED EMBODIMENT

For purposes of describing the preferred embodiment of the invention, the following definitions are adopted:

“High volume extraction” (hereinafter “HVE”), also known as high volume evacuation, means the high velocity or high volume suction source, equipped with a hose terminating in a valve within which short, large-diameter, disposable saliva ejectors are inserted, and which valve rests in a base near the patient when not in use.

“Slow speed suction”, also known as saliva ejection, means the low velocity or slow speed suction source, equipped with a hose terminating in a valve within which short, small-diameter, disposable saliva ejectors are inserted, and which valve rests in a base near the patient when not in use.

“Saliva ejector” (sometimes hereinafter “SE”), commonly referred to interchangeably with the term slow speed suction, shall be used in this description to refer only to the disposable suction devices typically inserted in the valve of slow speed suction defined above, including aspirators and combination devices such as mirrors with integral suction enabling features.

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

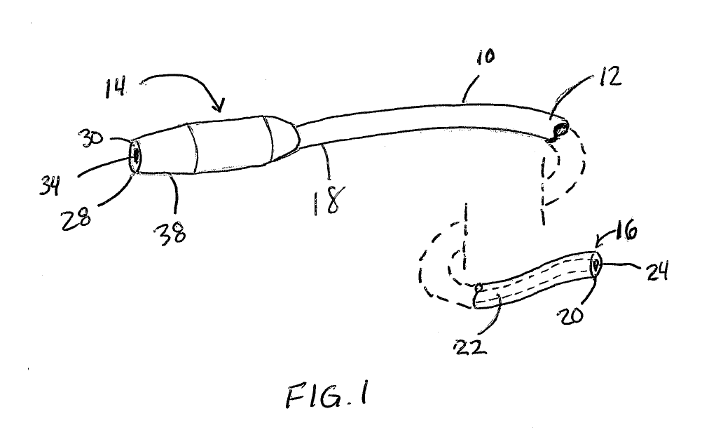

FIG. 1 depicts the suction tubing apparatus of the present invention 10 comprising a tube portion 12 and an adapter portion 14. The tube portion 12 further comprises a first or patient end 16 and a second or adapter end 18 connected by a wall 20 formed about an interior conduit 22. The interior conduit 22 terminates at each end of the tube portion 12 with an opening 24. The outside diameter (O.D.) of the tube portion 12 may be any industry standard for dental tubing. In the preferred embodiment the O.D. of the tube portion 12 is 0.250 (¼) inches. The diameter of the conduit 22, which is the inside diameter (I.D.) of the tube portion 12 formed by walls 20, is small enough to frictionally engage a small gauge saliva ejector, such as the Orsing Hygoformic™ ejector, in the opening 24. In the preferred embodiment the diameter of the conduit 22 is between 0.125 (⅛) and 0.1875 ( 3/16) inches, more preferably 0.146 ( 9/64) inches.

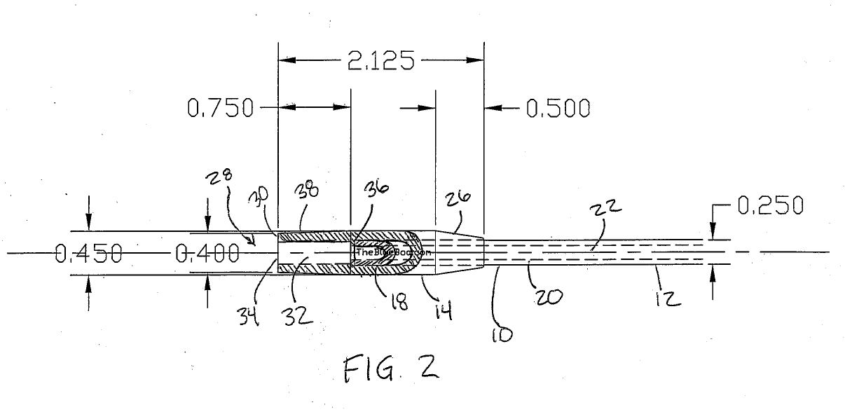

The adapter 14 is detailed in FIG. 2. The adapter portion 14 of the suction tubing 10 comprises an enlarged tube segment having a first or tube end 26, and a second or suction end 28, connected by a wall 30 formed about an interior conduit 32. The interior conduit 32 of the adapter 14 terminates at each end thereof with an opening 34. The O.D. of the adapter portion 14 may be any industry standard for high volume extraction tubing. In the preferred embodiment the primary O.D. of the adapter portion 14 is 0.450 inches, but having a functional taper 38 approaching the suction end 28, reducing the O.D. at the suction end 28 to 0.400 inches. In the preferred embodiment, the length of the taper 38 is 0.750 (¾) inches from the suction end 28. The taper 38 permits the adapter portion 14 to frictionally engage a standard HVE port sized to receive a 0.435 ( 7/16) inch HVE saliva ejector. In the preferred embodiment the I.D. of the adapter portion 14 is between 0.220 inches and 0.250 (¼) inches, and more preferably 0.230 inches.

In the preferred embodiment, the adapter end 18 of the tube 12 is permanently insertably engaged with the tube end 26 of the adapter 14 in the manner depicted in FIG. 2, using adhesive or fusing techniques known in the art of plastic fabrication and joinery. In other embodiments, mechanical fastening or friction insertion may also be used. In the preferred embodiment, the I.D. of the suction adapter 14 is the same throughout its entire length. The adapter end 18 of the tube portion 12 is inserted into the adapter tube end 26 to a depth sufficient to ensure adequate adhesion. The tube adapter end 18 is inserted to between 25% and 75% of the length of the tube end 26 of the adapter portion 14, and preferably to at least 50% of the length of the adapter portion 14. In the preferred embodiment of the invention, a 0.250 (¼) inch adapter or saliva ejector segment (not shown) may be inserted into the suction end 28 of the adapter portion 14, which adapter or segment may be insertably engaged to a slow speed suction valve having an orifice size of 0.250 (¼) inches (not shown). In this way, the suction tubing permits any saliva ejector to be used with slow speed suction.

The adapter 14 may optionally be formed as shown in FIG. 2 so that the adapter conduit 32 has formed therein an integrated constrictive annulus or stop 36 to serve as a guide for proper insertion depth of the tube adapter end 18. Alternatively, the optional stop 36 may be achieved by forming the adapter conduit 32 in multiple diameters such that the inside diameter of tube end 26 of the adapter 14 is sized to receive the outside diameter of the tube 12, and where the inside diameter of the suction end 28 of the adapter 14, beyond stop 36, is smaller than the outside diameter of the tube 12. In the preferred embodiment, suction adapter 14 has a length of 2.125 (2⅛) inches. Further, the preferred embodiment, the adapter end 18 of the tube 12 is inserted into the suction adapter 14, to a depth of approximately 1.375 (1⅜) inches and the two pieces are heat fused.

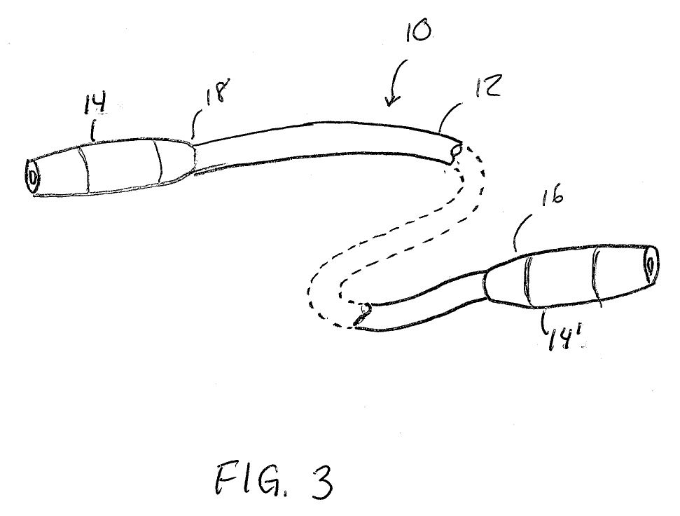

In another embodiment the entire suction tubing apparatus 10 of the present invention is formable as a single molded article. The suction end 28 of the suction tubing apparatus 10 may also be fashioned such that the source of suction could be inserted into the suction adapter 14 rather than inserting the suction adapter 14 into the suction valve orifice. In yet another embodiment of the invention, as shown in FIG. 3, the suction tubing 10 is fitted with two adapter portions 14 and 14′, one on the adapter end 18, and the second on the patient end 16. In this configuration, any saliva ejector that fits a standard 0.250 (¼) inch slow speed suction valve will also fit a 0.250 (¼) inch adapter suction end opening 34. In this manner, any slow speed suction saliva ejector can be adapted for use with HVE.

The length of the entire suction tubing apparatus 10 is selected to enable the saliva ejector to be positioned on either side of the mouth of the patient. Generally, the length will be between 30 and 72 inches (30″-72″), preferably between 36 inches and 48 inches (36″-48″). Most preferably, the suction tubing apparatus 10 is 42 inches (42″) in length. In the preferred range, and more particularly at the most preferred length, the suction tubing apparatus 10 is long enough to be positioned by the clinician on either side of the patient's mouth.

The suction tube apparatus is made from material selected for the characteristics of light weight. A suction tubing 10 of the present invention weighs between 0.75 and 1.5 ounces when fabricated with a single adapter 14, and between 1.0 and 2.0 ounces when fabricated with dual adapter ends 14 and 14′. The light weight of the apparatus 10 reduces cheek drag and other discomfort to the patient. Another purpose of fully positionable, light-weight suction tubing 10 is that it allows the clinician to position the patient, and the clinician to assume proper position and posture relative to the patient, enabling the clinician to avoid or diminish the need for postures that, over the course of time, may lead to fatigue and workplace injury.

The suction tubing 10 is made from material that is further selected for the characteristic of susceptibility to both chemical and temperature-based sterilization. It is constructed of material suitable for all types of sterilization including both cold sterilization or chemical sterilization, and hot sterilization or autoclaving. Susceptibility to autoclaving is particularly important due to suction tubing 10 length and small inside diameters involved. Autoclaving ensures complete sterilization, preventing cross contamination in the event of backflow during use.

Suitable materials of manufacture include, but are not limited to, rubber, silicone, vinyl, other thermoplastic polymers, thermosetting polymers and elastomers, and hybrid combinations of any of the foregoing. Adapter 14 and tube 12 may be, but are not required to be formed from the same material. In the preferred embodiment shown in the figures, the material of the separately molded adapter 14 is further selected for its compatibility with the tube portion 12 to properly heat fuse the pieces according to the preferred embodiment.

The material of manufacture is selected based on its ability to withstand both heat and vacuum pressure. The material of manufacture is further selected based on its ability to resist collapse under high volume extraction pressure. Preferably, the material possesses a durometer hardness of at least 40, preferably 60, according to ASTM D2240 Standard Test Method for Rubber Property. Material with at least the preferred durometer hardness score of 60 is particularly beneficial in suction tubing lengths exceeding 48 inches (48″). Alternatively, the suction tubing 10 made from such material will resist collapse under vacuum pressure in excess of 11 inches of mercury, preferably in excess of 15 inches of mercury.

Although the present invention has been described in considerable detail with reference to certain preferred versions thereof, other versions are possible. Therefore, the spirit and scope of the appended claims should not be limited to the description of the preferred versions contained herein. The reader's attention is directed to all papers and documents which are filed concurrently with this specification and which are open to public inspection with this specification, and the contents of all such papers and documents are incorporated herein by reference. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A light-weight suction tubing to be used by a dental clinician when performing procedures on a patient comprising:
a flexible tube having a tube portion and at least one adapter portion;
wherein the adapter portion is capable of frictionally engaging with a high volume extractor; and
wherein the tube portion is capable of frictionally engaging a disposable saliva ejector.

2. The apparatus of claim 1 wherein the material of manufacture is selected from the group consisting of rubbers, silicones, vinyls, thermoplastics polymers, thermosetting polymers, elastomers, and hybrid combinations of any thereof.

3. The apparatus of claim 1 wherein the material of manufacture is selected based on its ability to withstand sterilization by autoclave.

4. The apparatus of claim 1 wherein the material of manufacture is selected based on its ability to resist collapse under high volume extraction pressure.

5. The apparatus of claim 4 wherein the material possesses a durometer hardness of at least 40.

6. The apparatus of claim 4 wherein the suction tubing resists collapse under suction pressure in excess of 11 inches of mercury.

7. The apparatus of claim 1 wherein the length of the suction tubing is between 30 inches and 72 inches.

8. The apparatus of claim 1 wherein the suction tubing possesses two adapter portions.

9. The apparatus of claim 1 wherein the weight of the suction tubing does not exceed 1.5 ounces.

10. The apparatus of claim 8 wherein the weight of the suction tubing does not exceed 2 ounces.

11. A method of implementing hands-free fluid evacuation during dental procedures comprising the following:
selecting a light-weight suction tubing to be used by a dental clinician when performing procedures on a patient having a flexible tube portion and at least one adapter portion, wherein the adapter portion is capable of frictionally engaging with a high volume extractor, and wherein the tube portion or a second adapter portion is capable of frictionally engaging a disposable saliva ejector;
attaching the adapter of said suction tubing to a suction source;
attaching a the tube portion or a second adapter portion to a disposable saliva ejector; and
positioning said disposable saliva ejector in the mouth of the patient so as to provide hands-free fluid evacuation during a dental procedure.

12. The method of claim 11 wherein the material of manufacture is selected from the group consisting of rubbers, silicones, vinyls, thermoplastics polymers, thermosetting polymers, elastomers, and hybrid combinations of any thereof.

13. The method of claim 11 wherein the material of manufacture is selected based on its ability to withstand sterilization by autoclave.

14. The method of claim 11 wherein the material of manufacture is selected based on its ability to resist collapse under high volume extraction pressure.

15. The method of claim 14 wherein the material possesses a durometer hardness of at least 40.

16. The method of claim 14 wherein the suction tubing resists collapse under suction pressure in excess of 11 inches of mercury.

17. The method of claim 11 wherein the length of the suction tubing is between 30 inches and 72 inches.

18. The method of claim 11 wherein the suction tubing possesses two adapter portions.

19. The method of claim 11 wherein the weight of the suction tubing does not exceed 1.5 ounces.

20. The method of claim 18 wherein the weight of the suction tubing does not exceed 2 ounces.
